(19) United States
(12) Patent Application Publication
(10) Pub. No.: US 2005/0046618 A1
(43) Pub. Date: Mar. 3, 2005

(54) Plasma display module with improved heat dissipation characteristics

(76) Inventors: Sok-San Kim, Cheonan-si (KR); In-Soo Cho, Seongnam-si (KR); Ki-Jung Kim, Cheonan-si (KR); Tae-Kyoung Kang, Asan-si (KR)

Correspondence Address: Robert E. Bushnell, Suite 300, 1522 K Street, N.W., Washington, DC, 20005-1202, US

(21) Appl. No.: 10/902,892

(22) Filed: Aug. 2, 2004

(30) Foreign Application Priority Data
Sep. 1, 2003 (KR) 2003-60744

(51) Int. Cl. G09G 3/28

(52) U.S. Cl. 345/60

(57) ABSTRACT

Provided are designs for a plasma display module (PDM) that has a plasma display panel (PDP) and a chassis base with circuits mounted thereon. Heat dissipating layers and plane structures are formed between the PDP and the chassis base. The heat dissipating layer and the plane structure have novel shapes and sizes and are made out of specific materials or combinations of materials to improve the heat dissipating characteristics for the PDM. Preferably, a high-orientation graphite material having a high thermal conductivity is used for the heat dissipating layer. The plane structure is a highly conductive metal that is positioned between the graphite layer and the glass PDP to form a better contact to the PDP, to better draw heat away from the PDP and to allow for easy attachment and detachment of the graphite layer to the PDP.

### CLAIM OF PRIORITY

This application makes reference to, incorporates the same herein, and claims all benefits accruing under 35 U.S.C. §119 from an application for PLASMA DISPLAY MODULE earlier filed in the Korean Intellectual Property Office on 1 Sep. 2003 and there duly assigned Serial No. 2003-60744.

### BACKGROUND OF THE INVENTION

1. Field of the Invention

The present invention relates to a plasma display module, and more particularly, to a structurally improved plasma display module that has a uniform temperature distribution profile and a higher heat transfer efficiency.

2. Description of the Related Art

A plasma display module (PDM) is a flat panel display device for displaying pictures by using a discharge effect. Because of its very good performances and characteristics such as high display capacity, brightness, contrast, latent image, viewing angle, and thin and large screen size, the PDM is considered to be one of the next generation display devices.

Generally, a PDM includes a plasma display panel having a front panel and a rear panel and a chassis base having a circuit board for driving the plasma display panel on the back side the chassis base. Since the PDM uses a discharge effect for displaying pictures on the plasma display panel, a large amount of heat is generated from the plasma display panel. Therefore, a heat dissipating member is disposed between the plasma display panel and the chassis base to conduct the heat to the chassis base.

A heat dissipating member may be formed of a resin compound filled with a heat conductive material. The heat dissipating member formed is directly attached to a surface of the plasma display panel. One problem with such a design is that the heat transfer effect of the heat dissipating member is low because the materials used for manufacturing the heat dissipating member have a low thermal conductivity coefficient of about 1 W/m·K. In such a scenario, when there is a local temperature increase due to a poor heat transfer performance of the plasma display panel in a plane direction (i.e., in a direction parallel to the surface), the light emission efficiency of the phosphor layers in the discharge cells at the locally high temperatures can be reduced. As a result, a bright latent image (i.e., the difference in intensity between different cells) can occur, resulting in an overall brightness reduction. This problem then results in an increase in the discharge strength to achieve a bright image which results in yet more heat generated from the plasma display panel, causing the bright latent image problem to be even more severe. Also, the local temperature increase in the plasma display panel can generate an internal heat stress that can cause a crack of the plasma display panel which is usually made of glass.

The concept of employing a high conductivity heat dissipating member formed of high-orientation graphite to improve the temperature non-uniformity in a plasma display panel to increase the heat transfer efficiency is disclosed in U.S. Pat. No. 5,831,374 to Morita et al. However, the heat transfer performance in Morita '374 is still not sufficient because of pores generated in the heat dissipating member when attaching the heat dissipating member between the plasma display panel and the chassis base. The surface covered by the heat dissipating member is practically about 10˜15% due to the pores. Also, the high conductivity heat dissipating member is hard to attach to and detach from the plasma display panel. Especially, when removing the heat dissipating member, remaining portions of the heat dissipating member must be manually removed from the plasma display panel with a sharp object.

### SUMMARY OF THE INVENTION

It is therefore an object of the present invention to provide a design for a plasma display module that can provide improved temperature uniformity on a plasma display panel.

It is further an object of the present invention to provide a design for a plasma display panel where the heat dissipating member can easily be attached to and detached from the plasma display panel.

It is also an object of the present invention to provide a design for a plasma display module that has an improved heat transfer performance.

These and other objects may be achieved with a plasma display module (PDM) made up of a plasma display panel (PDP) on which a picture is displayed, a chassis base disposed facing the PDP, a circuit board driving the plasma display panel formed on the chassis base, a heat dissipating member sandwiched in between the PDP and the chassis base, and a plate structure contacting a surface of heat dissipating member and facing the plasma display panel and a surface of heat dissipating member facing the chassis base. The plate structure is preferably made of a material that is strong enough to resist the tensile strength caused by removing the heat dissipating member from the PDP.

Preferably, the heat dissipating member is made out of a material with a very high thermal conductivity, such as high-orientation graphite. This graphite allows for superb thermal conductivity, especially in a planar direction, thus providing better temperature uniformity across the PDP and reducing or eliminating any temperature gradients across the PDP. The plate structure, preferably made out of a metal like aluminum, is disposed between the graphite and the PDP so the graphite does not directly contact the PDP. This plate structure allows for easy attachment and detachment of the graphite to the PDP, improves temperature uniformity across the PDP, and better draws heat away from the PDP. The plate structure can also be formed between the graphite and the chassis base.

The plate structure may be in a form of a flat plate, or instead may be a sealing member that completely surrounds and seals the heat dissipating member. When the plate structure is a sealing member, the heat dissipating member can be a liquid heat transfer material, or a powder type conductive material filled in the plate structure.

The plate structure may include at least a first extension that extends toward outside of the PDM to allow cooling the plasma display panel by air, and in this case, the first extension may include a cooling fin. The plate structure may also include at least a second extension that extends toward the heat dissipating member, in this case, the second extension may be a protrusion formed on a surface of the plate structure contacting the heat dissipating member. Also, the plate structure may include a connection that connects together the PDP side of the plate structure to the chassis base side of the plate structure. The plate structure is preferably made out of a thermally conductive material such as Al, Cu, Ag, and Ni, and a conductive material may also be coated on the plate structure. The heat dissipating member is preferably made of a high-orientation graphite. The plate structure may be attached to the PDP using an adhesive and the plate structure may be attached to the chassis base using an adhesive. The PDP and the chassis base may be combined together using a double sided adhesive placed at the rim of the PDP and the chassis base, and the plate structure may be fixed therebetween or within the rim.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display module (PDM) according to an exemplary embodiment of the present invention;

FIG. 2 is a cross-sectional view taken along line A-A in FIG. 1;

FIGS. 3 and 4 are cross-sectional views of PDMs according to different exemplary embodiments of the present invention;

FIG. 5 is a schematic drawing illustrating a heat transfer route of a PDM depicted in FIG. 4;

FIG. 6 is a perspective view of a PDM according to another exemplary embodiment of the present invention; and

FIGS. 7 through 9 are cross-sectional views of PDMs according to different exemplary embodiments of the present invention.

### DETAILED DESCRIPTION OF THE INVENTION

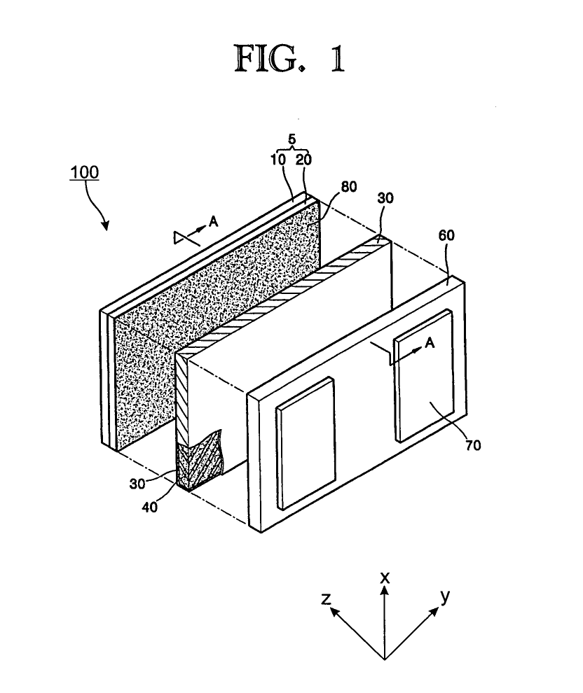

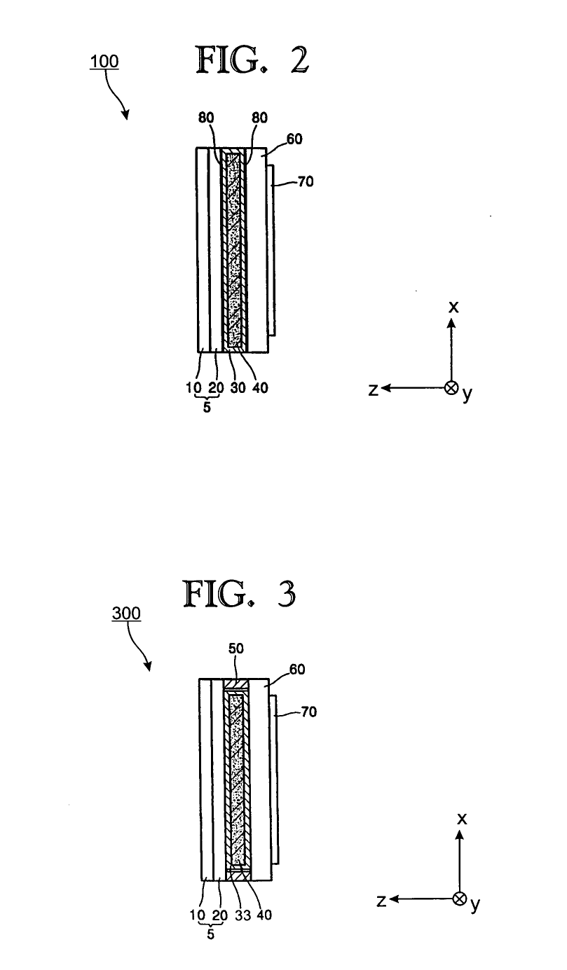

FIG. 1 is an exploded perspective view of a plasma display module (PDM) 100 according to an embodiment of the present invention, and FIG. 2 is a cross-sectional view of the PDM 100 taken along line A-A in FIG. 1. Turning now to FIGS. 1 and 2, the plasma display module 100 includes a plasma display panel (or PDP) 5, a chassis base 60, a circuit board 70, and a heat dissipating member 40 and a plate structure 30. The heat dissipating member 40 and the plate structure 30 are disposed between the PDP 5 and the chassis base 60. The PDP 5 is made up of a front panel 10 and a rear panel 20. The PDP 5 is generally formed of glass and represents the image display section of PDM 100 that displays images via plasma discharge.

The chassis base 60 performs as a heat sink for promoting heat transfer from the PDM 5 and from the circuit board 70. Chassis base 60 is preferably made of a material having a superior thermal conductivity, such as aluminum. A circuit board 70 is disposed on a back surface of the chassis base 60 and includes circuit substrates (not illustrated).

The heat dissipating member 40 sandwiched between the PDP 5 and the chassis base 60 as depicted in FIGS. 1 and 2 can be formed of a high-orientation graphite. A crystal structure of the high-orientation graphite has an arrangement structure to promote heat conduction more fluently in a plane direction (x and y directions) rather than a thickness direction (z-direction).

The high-orientation graphite can be formed through an annealing process or carbonization of a particular polymer compound after depositing carbon atoms by a chemical vapor deposition method using hydrocarbon gas. The high-orientation graphite obtained by the carbonization of a particular polymer compound has superior thermal conductivity. The particular polymer compound is preferably polyoxadiazoles(POD), polybenzothiazole(PBT), polybenzo-bis-thiazole(PBBT), polyzooxazole(PBO), polybenzo-bis-oxazole(PBBO), polyimides(PI), polyamides(PA), polyphenylene-benzoimidazole(PBI), polyphenylene-benzo-bisimidazole(PPBI), polythiazole(PT), or polyparaphenylene-vinylene(PPV).

The baking process for carbonizing the polymer compound does not require a specific operating condition but the baking is preferably performed above 2,000° C. because the high-orientation graphite can easily solidify below 2,000° C. A highest carbon orientation can be achieved at a temperature of about 3,000° C.

Baking is preferably performed in the presence of an inert gas atmosphere, and preferably performed under a pressure higher than atmospheric pressure to reduce an effect of process gases generated during baking. If necessary, a rolling process can be performed after the baking process.

The high-orientation graphite can be manufactured in a film type or a bulk type, and the heat dissipating member 40 can be made by stacking a plurality of high-orientation graphite films or by a single high-orientation graphite bulk piece.

The high-orientation graphite has elasticity according to the method of manufacturing. The high-orientation graphite preferably has an elasticity to maintain an adherence force, and to overcome the differences of the thermal expansion coefficient between the plasma display panel 5 and the chassis base 60.

The high thermal conductivity heat dissipating member 40 preferably has a thermal conductivity of more than 150 W/m·K, which is much higher than other heat transfer materials which have a thermal conductivity of about 1 W/m·K. Especially, the high thermal conductivity heat dissipating member 40 has an advantage of promoting the thermal conductivity in a plane direction (i.e., x and y directions) due to the anisotropic thermal conductivity of high-orientation graphite.

The heat dissipating member 40 can be manufactured not only of the high-orientation graphite but also of other various materials. For example, when the plate structure 30 is a sealing member that completely surrounds and encapsulates the heat dissipating member 40 as depicted in FIG. 1, the heat dissipating member 40 can be a liquid heat transfer material such as a heat transfer gel or a heat transfer grease, or could instead be a powder type thermal conductivity material that appropriately agglomerates in the plate structure 30. The powder type thermal conductivity materials can be carbon powder or aluminum powder.

The heat dissipating member 40 manufactured of a liquid heat transfer material or a powder type thermal conductivity material has isotropic thermal conductivity characteristics meaning that the thermal conductivity in the plane direction is equal to the thermal conductivity in the thickness direction.

In the PDM 100 configured as above, the heat dissipating member 40 according to an aspect of the present invention includes the plate structure 30 that contacts at least one of the PDP 5 and the chassis base 60.

The plate structure 30 of FIG. 2 can be a sealing member that receives the heat dissipating member 40. The thin plate structure 30 of FIG. 2 can be made to easily and tightly attach to a surface of the PDP 5 by pressing due to superior deformity of the thin plate structure 30. The plate structure 30 can be formed of a high thermal conductivity material such as Al, Cu, Ag, or Ni, and a conductive material can be coated on the plate structure 30.

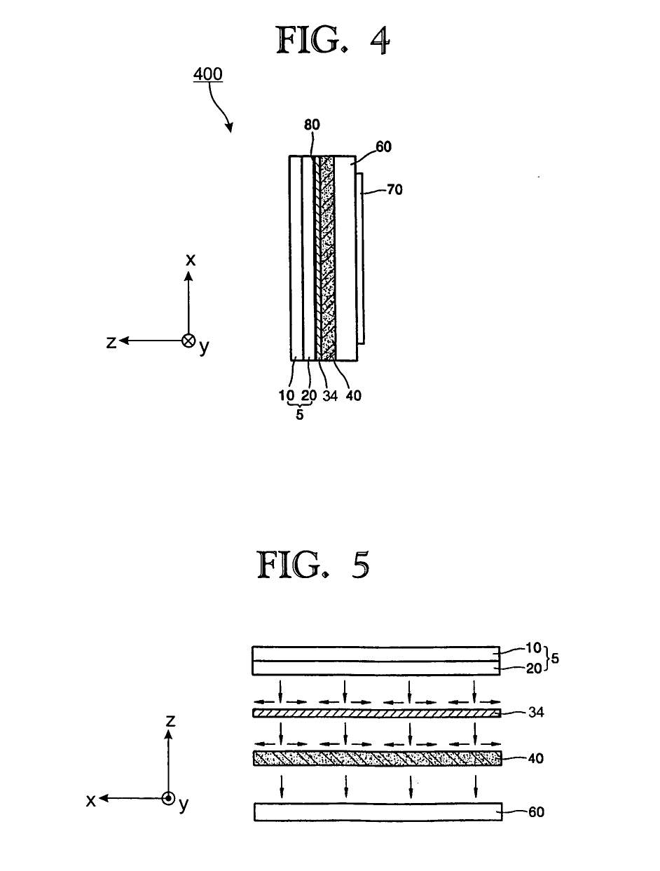

The plate structure 30 of FIG. 2 can be attached to the plasma display panel 5 and to the chassis base 60 by using an adhesive 80. Alternatively, in the PDM 300 illustrated in FIG. 3, the PDP 5 and the chassis base 60 can be attached to each other using a double sided adhesive 50 attached to a rim (or edges) of the chassis base 60. In the PDM 300 of FIG. 3, the plate structure 33 is fixed within the adhesive rim 50.

Turning now to FIG. 4, FIG. 4 is a cross-sectional view of a PDM 400 according to another exemplary embodiment of the present invention. As depicted in FIG. 4, the PDM 400 has a plate structure 34. Adhesiveness of the plate structure 34 to the PDP 5 is increased when the plate structure 34 is a thin film such as a foil type because of the a high deformity thereof. The plate structure 34 has a high thermal conductivity, and can be formed of a high thermal conductivity material such as Al, Cu, or Ni, and a conductive material can also be coated on the plate structure 30. As depicted in FIG. 4, the plate structure 34 can be attached to the PDP 5 using an adhesive 80.

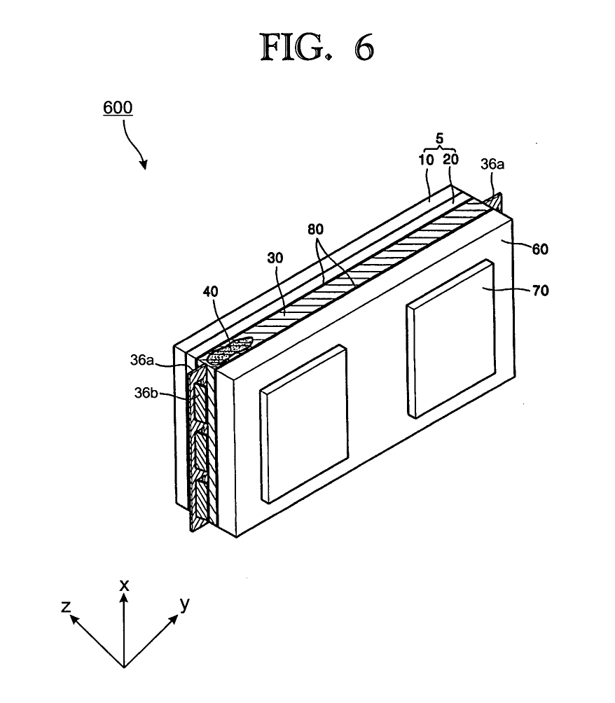

Turning now to FIG. 5, FIG. 5 illustrates a schematic drawing showing a heat transfer in a PDM 400 of FIG. 4 from the PDP 5 to the chassis base 60. As illustrated in FIG. 5, the heat transfer in a plane direction (x and y directions) of the PDP 5 is increased because the plate structure 34 is formed of a high thermal conductivity material and the plate structure 34 of this high thermal conductivity material is disposed between the PDP 5 and the chassis base 60. This plate structure 34 having the high thermal conductivity material together with a high thermal conductive heat dissipating member 40 formed of a high-orientation graphite both disposed between the PDP 5 and the chassis base 60 results in a more uniform heat distribution over the plane of the PDP 5.

Accordingly, the use of the above plate structure 34 in a PDM can provide advantages in that the bright latent image is reduced or removed, heat stress due to the local temperature increase can be removed, durability of the plasma display panel is increased, and plasma display panel breakage due to cracking can be prevented. Additionally, when a uniform temperature profile over the PDP 5 is achieved, overall heat transfer efficiency of the PDP 5 is increased since heat transfer from the PDP 5 to the chassis base 60 is also uniformly conducted. When attaching a heat dissipating member 40 that has low adhesion ability to the PDP 5 formed of glass, the attaching force can be increased by disposing a plate structure 34 formed of a metal between the PDP 5 and the high conductivity heat dissipating member 40. Moreover, a thermal fatigue of the components that constitute the PDM 400 can be reduced when rapid heat transfer is achieved, thereby increasing the length of the life of the product and also reducing manufacturing cost by eliminating the need for a cooling fan installed in the PDM 400.

The improved attaching method for PDM 400 of FIG. 4 is to attach the heat dissipating member 40 to the PDP 5 by having the plate structure 34 between the PDP 5 and the heat dissipating member 40 so that it is the plate structure and not the heat dissipating material that directly contacts the glassy PDP 5. By having plate structure 34 instead of heat dissipating member 40 come into direct contact with the PDP 5, the yield in the productivity can be improved. When it is necessary to remove the heat dissipating member 40 from the PDP 5 for reworking or repairing, the heat dissipating member 40 can be removed as one body together with the plate structure 34 and the plate structure 34 can resist the plane tensile force caused by detaching.

If the plate structure is a sealing member that seals or encapsulates the heat dissipating member 40, the heat dissipating member 40 can be formed in a liquid phase or a gel type, or an appropriately agglomerated powder having high thermal conductivity such as aluminum or carbon powder. The advantages of the above description will now be described based on the following comparison.

[Exemplary Comparison]

Table 1 illustrates empirical test results of radiating performance of different heat dissipating members. The first column of Table 1 illustrates empirical data for a PDM when the heat dissipating member is formed of silicon with a thickness of 1.5 mm and is disposed between the PDP and the chassis base. The second column of Table 1 illustrates empirical data when the heat dissipating member is made of a high thermal conductivity material with a thickness of 1.5 mm and is disposed between the PDP and the chassis base. The third and last column of Table 1 illustrates the empirical test results for a heat dissipating member made of a high thermal conductivity material with a thickness of 1.5 mm where the heat dissipating member also contains an aluminum thin film, where the entire heat dissipating member is disposed between the plasma display panel and the chassis base.

TABLE 1

| | 1.5 mm | 1.5 mm High | 1.5 mm, High |
|---|---|---|---|
| | Silicon | thermal | thermal conduc- |
| | heat | conductivity | tivity heat dissi- |
| | dissipating | heat dissi- | pating member + |
| Item | member | pating member | Thin aluminum foil |
| Bright latent image | 22 | 11 | 9 |
| (in cd/m²) | | | |
| Bright latent image | 170 | 60 | 45 |
| time (in seconds) | | | |
| Surface Temperature | 64 | 54 | 50 |
| of plasma display | | | |
| panel (° C.) | | | |

To compare the heat transfer performances for each case, a bright latent image, a bright latent image time, and a surface temperature of the plasma display panel are measured by emitting light in a manner that a predetermined region A of the PDM was lighted, and ten minutes later, the region A and the remaining region B of the PDM were lighted. In the first row, “bright latent image” means the difference in brightness between regions A and B after the ten minutes where only region A is lit followed immediately by 30 seconds of where both regions A and B are lit. As can be reasoned, the better designed PDM has a higher thermal conductivity resulting in a lower difference in image brightness between regions A and B after the 10 minutes followed by the 30 seconds.

The second row is called “bright latent image time” and is the time required after the ten minutes of lighting region A only where both regions A and B are lit and the difference in brightness between these two regions A and B falls to 7 cd/m². The better designed PDM would have better thermal conductivity characteristics resulting in less time for region A and B to have a difference in brightness of 7 cd/m².

The last row is the temperature of the PDP at region A after region A only has been emitting light for 10 minutes. A better designed PDM would have improved thermal conductivity resulting in a lower temperature.

As can be seen from Table 1, the high thermal conductivity heat dissipating member of column 2 outperformed the silicon heat dissipating member of column 1 for all three tests. The heat dissipating member having the thin aluminum foil of column 3 outperformed both the silicon heat dissipating member of column 1 and outperformed the high thermal conductivity heat dissipating member of column 2. From these results, the use of the heat dissipating member formed of the high thermal conductivity material and the thin aluminum foil can quickly reduce the temperature gradient formed on the region A because heat transfer in the plane direction is promoted.

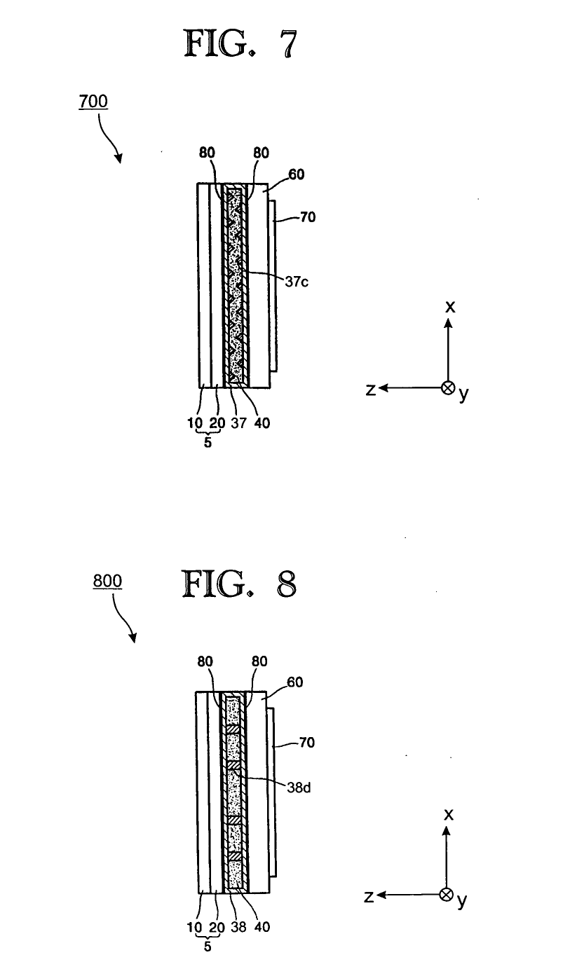

Turning now to FIGS. 6, 7, 8 and 9, FIGS. 6, 7, 8 and 9 illustrate PDMs 600, 700, 800 and 900 respectively having different exemplary forms of plate structures 36, 37, 38 and 39 respectively that can be applied to the present invention. Referring to FIG. 6, the plate structure 36 can include a first extension 36a, a portion of the plate structure that is extended outward from the edge of the PDM 600. As illustrated in FIG. 6, the first extension 36a protrudes in a y-direction (or lateral direction) from the edge of plate structure 36 of the PDM. Plate structure 36 can also further include cooling fins 36b for accelerating cooling by air.

When the first extension 36a is included in the design of the plate structure 36, a portion of heat generated in the PDP 5 is directly cooled by air on the plate structure 36 instead of transferring all the heat to the chassis base 60. In other words, since first extension 36a of plate structure 36 extends into cool air, this cool air on the outside of PDM 600 that contacts first extension 36a and cools first extension 36a, thus reducing the temperature of plate member 36. By such a design, the heat transfer efficiency is improved and less heat is transferred to chassis base 60 from PDP 5 than if first extension 36a were not present. With this reduction in temperature on chassis base 60, the circuit board 70 disposed on the backside of the chassis base 60 is less likely to overheat and malfunction.

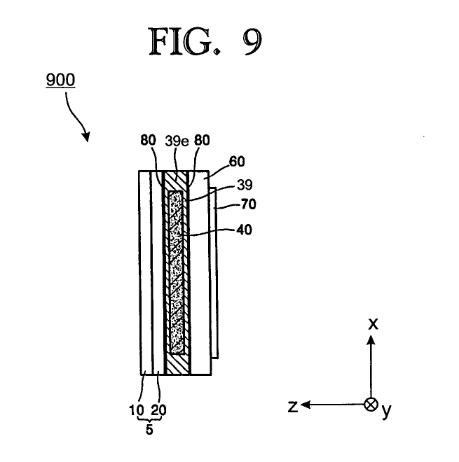

Turning now to the PDM 700 illustrated in FIG. 7, the plate structure 37 includes second extension 37c which are protrusions which extend in a z-direction into the heat dissipating member 40. The second extension 37c increases the contact area between the plate structure 37 and heat dissipating member 40, thereby increasing the heat transfer efficiency from the PDP 5. The presence of second extension 37c in the design of a plate structure 37 is particularly effective when the heat dissipating member 40 is formed of a liquid heat transfer material.

Turning now to FIG. 8, FIG. 8 illustrates a PDM 800 according to another embodiment of the present invention. In the embodiment of FIG. 8, the design of the plate structure 38 is modified to include a connection 38d that connects the plasma display panel side of the plate structure 38 with and the chassis base side of plate structure 38. The connection 38d, as depicted in FIG. 8, extends through the heat dissipating member 40. The heat dissipating member 40 may be solid, or in the case that the plate structure 38 is sealed, may be liquid and/or powder.

Turning now to FIG. 9, FIG. 9 illustrates another design for a PDM 900 according to another embodiment of the present invention. As illustrated in FIG. 9, the design of the plate structure 39 is again modified to produce improved results. As illustrated in FIG. 9, plate structure 39 includes connectors 39e that are disposed along the rim (or edges) of the heat dissipating member 40 and along the rim (or edges) of the plate structure 39.

As with connection 38d of FIG. 8, when the connectors 39e of FIG. 9 contain a high thermal conductive material such as aluminum, heat generated in the PDP 5 can be directly transferred to the chassis base 60 without having to pass through the heat dissipating member 40. Again, improved heat dissipation can be achieved.

The PDMs according to the present invention have the following advantages. By using the above designs for plate structures and heat dissipating members and the above materials for the plate structures and heat dissipating members located between the PDP and the chassis base, a more uniform temperature distribution profile can be achieved across of the PDP. When a plate structure is formed of a high thermal conductivity material and is disposed between a plasma display panel and a heat dissipating member, improved heat transfer in a plane direction across the surface of the PDP is better realized. Also, by using high-orientation graphite for a heat dissipating member, temperature transfer in a plane direction is further accelerated.

By reducing temperature gradients along a surface of the PDP, a bright latent image can be reduced or removed. Also, a breakage of the PDP due to thermal stress caused by local heating can be prevented, thereby extending lifetime of the PDM. When a uniform temperature profile is achieved on the PDP, heat transfer to the chassis base is also uniform, thereby increasing overall heat transfer efficiency.

Second, the heat transfer performance is improved by the tight contact between the PDP of the PDM and the heat dissipating member. The tight contact between the PDP that is formed of glass and a heat dissipating member formed of a high thermal conductivity material that has a low contacting force with glass can be achieved by having a plate structure formed of a metal between the glass PDP and the heat dissipating member.

Third, the use of the plate structure makes it easier to attach and detach the heat dissipating member to the PDP, resulting in reduced process loss and increased production yield. When the heat dissipating member needs to be separated from the PDP for reworking or repairing, the heat dissipating member can be removed as one body since the plate structure can resist the plane tensile force that occurs during detaching.

While this invention has been particularly shown and described with reference to preferred embodiments thereof, it will be understood by those skilled in the art that various changes in form and details may be made therein without departing from the spirit and scope of the invention as defined by the appended claims.

1. A plasma display module, comprising:
a plasma display panel on which an image is displayed;
a chassis base arranged facing the plasma display panel;
a circuit board driving the plasma display panel, the circuit board being supported by the chassis base;
a heat dissipating member arranged between the plasma display panel and the chassis base; and
a plate structure contacting at least one of a surface of the heat dissipating member facing the plasma display panel and a surface of the heat dissipating member facing the chassis base.

2. The plasma display module of claim 1, wherein the plate structure is strong enough to resist a plane tensile strength that occurs during removal of the heat dissipating member from the plasma display panel.

3. The plasma display module of claim 1, wherein the plate structure is in a form of a flat plate.

4. The plasma display module of claim 1, wherein the plate structure is a sealing member that seals the heat dissipating member.

5. The plasma display module of claim 4, wherein the heat dissipating member is a liquid heat transfer material.

6. The plasma display module of claim 4, wherein the heat dissipating member is a powder type conductive material filled in the plate structure.

7. The plasma display module of claim 1, wherein the plate structure comprises a first extension that extends toward an outside of the plasma display module to allow cool air on an outside of the plasma display module to directly contact said first extension.

8. The plasma display module of claim 7, wherein the first extension further comprises a cooling fin.

9. The plasma display module of claim 1, wherein the plate structure comprises a second extension that extends inward toward the heat dissipating member.

10. The plasma display module of claim 9, wherein the second extension is a protrusion formed on a surface of the plate structure that directly contacts the heat dissipating member.

11. The plasma display module of claim 1, wherein the plate structure comprises a connection member that connects the plasma display panel side of the plate structure to the chassis base side of the plate structure.

12. The plasma display module of claim 1, wherein the plate structure comprises a thermally conductive material.

13. The plasma display module of claim 12, wherein the plate structure is comprised of a thermally conductive material selected from the group consisting of Al, Cu, Ag, and Ni, the plate structure further comprises a conductive material that is coated to the thermally conductive material.

14. The plasma display module of claim 1, wherein the heat dissipating member comprises a high-orientation graphite.

15. The plasma display module of claim 1, wherein the plate structure is attached to the plasma display panel via an adhesive.

16. The plasma display module of claim 1, wherein the plate structure is attached to the chassis base via an adhesive.

17. The plasma display module of claim 1, wherein the plasma display panel and the chassis base are combined using a double sided adhesive placed at a rim of the plasma display panel and the chassis base, the plate structure being arranged therebetween inside said rim.

18. A plasma display module, comprising:
a plasma display panel on which an image is displayed;
a chassis base arranged facing the plasma display panel;
a circuit board driving the plasma display panel, the circuit board being supported by the chassis base;
a high-orientation graphite layer interposed between the plasma display panel and the chassis base; and
a thin, thermally conductive metal layer arranged between the high-orientation graphite layer and the plasma display panel.

19. The plasma display module of claim 18, the high-orientation graphite layer does not directly contact the plasma display panel.

20. A plasma display module, comprising:
a plasma display panel on which an image is displayed;
a chassis base arranged facing the plasma display panel;
a circuit board driving the plasma display panel, the circuit board being supported by the chassis base;
a heat dissipating liquid heat transfer material; and
a plate structure made of a thermally conductive metal and formed to encapsulate the heat dissipating member, the plate structure and the liquid being arranged between the plasma display panel and the chassis base.
